(19) United States
(12) Patent Application Publication
(10) Pub. No.: US 2024/0011623 A1
(43) Pub. Date: Jan. 11, 2024

(54) Gutter-Mounted Light Storage Device

(71) Applicant: Rona Connelly, Pennsville Town, NJ (US)

(72) Inventor: Rona Connelly, Pennsville Town, NJ (US)

(21) Appl. No.: 18/168,033

(22) Filed: Feb. 13, 2023

Related U.S. Application Data
(60) Provisional application No. 63/358,979, filed on Jul. 7, 2022.

(51) Int. Cl. F21V 15/01; E05B 65/52; F21V 23/04; F21S 9/03

(52) U.S. Cl. CPC F21V 15/01; E05B 65/52; F21V 23/0435; F21S 9/037; F21W 2121/004

(57) ABSTRACT

The present invention relates to a gutter-mounted light storage device. The device is further comprised of at least one fastener located on the back surface to attach the device to a gutter. The device is further comprised of a front surface that moves around at least one hinge and locks in an open/closed position via at least locking mechanism and/or hinge lock. The device is also comprised of at least one power source to power the lights, as well as at least one solar panel to power the power source. The device is further comprised of an interior space, comprised of at least one fastener to hold the lights in place. The interior space is also comprised of at least one receiver that is in wireless electrical communication with the user's smart device via a mobile application.

### CROSS-REFERENCE TO RELATED APPLICATION

The present application claims priority to, and the benefit of, U.S. Provisional Application No. 63/358,979, which was filed on Jul. 7, 2022, and is incorporated herein by reference in its entirety.

### FIELD OF THE INVENTION

The present invention relates generally to the field of light storage devices. More specifically, the present invention relates to a gutter-mounted light storage device. The device is comprised of a top surface, a bottom surface, a front surface, an interior space, and a back surface. The device is further comprised of at least one fastener located on the back surface to attach the device to a gutter. The device is further comprised of a front surface that is moved around at least one hinge and locked in an opened/closed position via at least locking mechanism and/or hinge lock. The device is also comprised of at least one power source to power the lights, as well as at least one solar panel to power the power source. The device is further comprised of an interior space, comprised of at least one fastener to hold the lights in place. The interior space is also comprised of at least one receiver that is in wireless electrical communication with the user's smart device via a mobile application. Accordingly, the present disclosure makes specific reference thereto. Nonetheless, it is to be appreciated that aspects of the present invention are also equally applicable to other like applications, devices, and methods of manufacture.

### BACKGROUND

Hanging holiday lights can be a daunting task. It may take hours of preparation and installation to get lights exactly where an individual wants them on the exterior of a home. Most people do not like their holiday lights to be installed year-round. As a result, holiday lights must be installed and uninstalled with each holiday. Further, many individuals find it visually unappealing to have holiday lights hanging from their home year-round, or their Homeowners Association may forbid holiday lights out of season.

In addition, installing holiday lights can be a physically difficult task for older individuals. Further, being on a ladder for extended periods of time while installing lights can lead to an individual falling, thereby causing severe injury or death. Many people may want to install holiday lights, but inevitably choose not to because of the physical demands of installation, thus they do not get the pleasure of having the lights on their home. Holiday lights also may take up a large amount of storage space when they are not in use, making it difficult for an individual to find adequate storage space for the lights.

Therefore, there exists a long-felt need in the art for a device that allows a user to store holiday lights year-round without having to install and uninstall the lights frequently. There also exists a long-felt need in the art for a device that does not require a user to install and uninstall lights for every season. There also exists a long-felt need in the art for a gutter-mounted light storage device that attaches to a home's gutters and allows the user to leave holiday lights installed year-round while still concealing the lights from view when desired. There also exists a long-felt need in the art for a gutter-mounted light storage device that is in electrical communication with and can be controlled by a user's smart device via a mobile application.

The subject matter disclosed and claimed herein, in one embodiment thereof, comprises a gutter-mounted light storage device. The device is comprised of a movable front surface, a top surface, a back surface, an interior space, and a mobile application. The front surface is comprised of a hinge that allows the device to be moved to an open or closed position. The front surface is further held in an open position via a hinge lock, or in a closed position via a locking mechanism. The device is also powered by at least one power source, which may receive power via at least one solar panel. The device is also attached to a gutter via a fastener positioned on the back surface. The device also has a receiver that is in electrical communication with a user's smart device via a mobile application that allows for further customization.

In this manner, the gutter-mounted light storage device of the present invention accomplishes all of the foregoing objectives and provides a novel means of hanging and storing holiday lights. The device allows holiday lights to be hung and stored year-round by providing a means to expose or hide the lights without having to uninstall the lights.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a gutter-mounted light storage device. The device is primarily comprised of a body, comprised of a top surface, a bottom surface, a movable front surface, a side surface, and a back surface. The front surface can be opened or closed to either conceal or expose holiday lights stored within the lights. The front surface may be comprised of at least one hinge that allows the front surface to be rotated to an open or closed position. The device is also comprised of at least one hinge lock. The hinge lock locks the front surface in the open position and prevents the front surface from closing unless the hinge lock is disengaged. The device is also comprised of at least one locking mechanism that keeps the front surface in a closed position and prevents it from being opened by the wind or other environmental causes.

The back surface attaches to a gutter of a home via at least one fastener. The fastener allows the device to be securely fastened to the gutter without the risk of it becoming loose and falling from the gutter. In the preferred embodiment, the fastener is a universal fastener to allow the device to be attached to a plurality of differing gutters.

The device is also comprised of a top surface having at least one power source. In the preferred embodiment, the power source receives its power via at least one solar panel positioned on top of the top surface. The solar panel allows the power source to continually recharge so the user does not have to replace the power source.

In the preferred embodiment, there are a plurality of fasteners positioned within the interior space that allow holiday lights to be securely attached to the device. This prevents the lights from falling out of the interior space when the front surface is in the open position. The device is further comprised of at least one receiver positioned within the interior space of the device. The receiver is in wireless electrical communication with a mobile application on a user's smart device.

The mobile application may be comprised of color controls that allow the user to select what color the holiday lights emit. The mobile application may also be comprised of brightness controls that allow the user to change the brightness of the lights. The mobile application also may be comprised of functionality controls that allow the user to select the functions of the lights.

Accordingly, the gutter-mounted light storage device of the present invention is particularly advantageous as it allows the user to not have to repeatedly install and uninstall holiday lights. Further, the device provides a means for covering installed holiday lights when they are not in use without having to uninstall all the lights. In this manner, the gutter-mounted light storage device overcomes the limitations of existing light storage devices known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a gutter-mounted light storage device of the present invention in accordance with the disclosed architecture;

FIG. 2 illustrates an enhanced perspective view of one potential embodiment of a gutter-mounted light storage device of the present invention in an open position in accordance with the disclosed architecture;

FIG. 3 illustrates an enhanced perspective view of one potential embodiment of a gutter-mounted light storage device of the present invention in a closed position in accordance with the disclosed architecture; and

FIG. 4 illustrates a graphical view of one potential embodiment of a mobile application of one potential embodiment of a gutter-mounted light storage device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that allows a user to store holiday lights year-round without having to install and uninstall the lights frequently. There also exists a long-felt need in the art for a device that does not require a user to install and uninstall lights for every season. There also exists a long-felt need in the art for a gutter-mounted light storage device that attaches to a home's gutters and allows the user to leave holiday lights installed year-round while still concealing the lights from view when desired. There also exists a long-felt need in the art for a gutter-mounted light storage device that is in electrical communication with and can be controlled by a user's smart device via a mobile application.

The present invention, in one exemplary embodiment, is comprised of a gutter-mounted light storage device. The device is primarily comprised of a movable front surface, a top surface, an interior space, a back surface, and a mobile application. The front surface is comprised of at least one hinge that allows the front surface to rotate to the open or closed position, thus either hiding or exposing the lights. The front surface is also comprised of at least one locking mechanism that holds the front surface shut, and at least one hinge lock that holds the front surface open. The device is further comprised of at least one power source that powers the lights. The power source receives its power from at least one solar panel positioned on the top surface. The back surface is comprised of a fastener that attaches the device to a plurality of gutters for secure connection.

The interior space is comprised of at least one fastener that holds the lights in place. The interior space is also comprised of at least one receiver that is in wireless electrical communication with the user's smart device via a mobile application. This allows the user to customize the lights remotely.

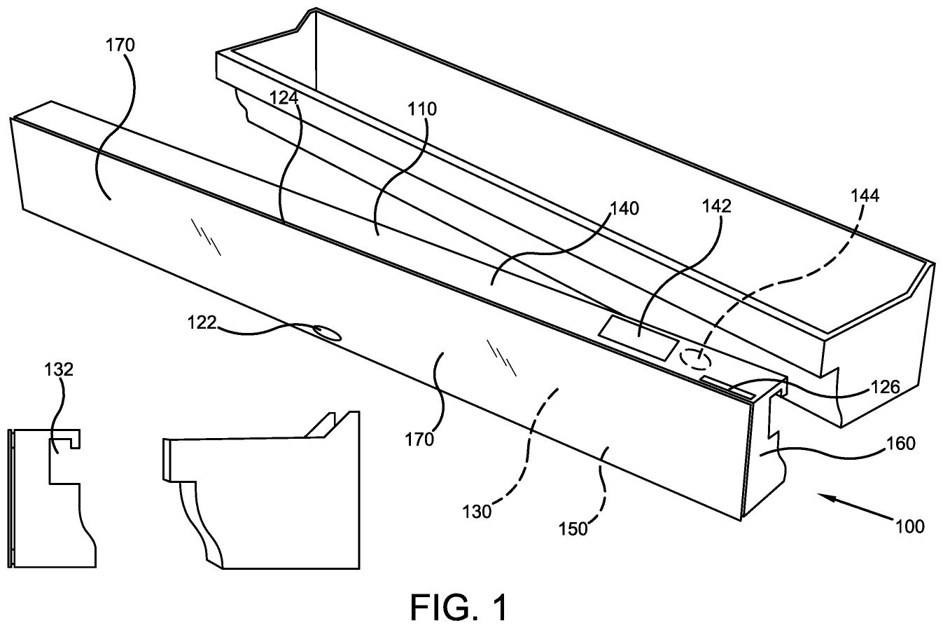

Referring initially to the drawings, FIG. 1 illustrates a perspective view of one potential embodiment of a gutter-mounted light storage device 100 of the present invention in accordance with the disclosed architecture. The device 100 is primarily comprised of a body 110 comprised of a top surface 140, a bottom surface 150, a movable front surface 120, a side surface 160, and a back surface 130. In the preferred embodiment, the body 110 may be manufactured from a metal material such as, but not limited to: aluminum, stainless steel, tin, copper, etc. In a differing embodiment, the device may be manufactured from a rigid plastic material such as, but not limited to, acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc.

The device 100 is also comprised of a front surface 120 that can be opened or closed to either conceal or expose holiday lights 12 stored within the device 100. The front surface 120 may be comprised of at least one hinge 124 that allows the front surface 120 to be rotated to an open/closed position. There are a plurality of hinges 124 that may be used such as, but not limited to, an offset blind hinge, a knuckle hinge, a butt hinge, a rising butt hinge, a gravity pivot hinge, a ball bearing hinge, a barrel hinge, a concealed hinge, a knife hinge, a piano hinge, a strap hinge, a pivot hinge, a gas-piston hinge, an injection molded hinge, a locking hinge, etc.

The device 100 is also comprised of at least one hinge lock 126. The hinge lock 126 locks the front surface 120 in the open position and prevents the front surface 120 from closing unless the hinge lock 126 is disengaged. In the preferred embodiment, the hinge lock 126 is in the form of a fastener such as, but not limited to, a magnet, a screw, a nut, a bolt, a carriage bolt, a nail, an anchor bolt, an acorn nut, a threaded rod, a retaining ring, a rivet, a set screw, a toggle bolt, an anchor, a self-tapping screw, an adhesive, a u-bolt, a lock nut, a castle nut, etc.

The device 100 is also comprised of at least one locking mechanism 122 that secures the front surface 120 in a closed position and prevents the front surface 120 from being opened by the wind or other unintentional causes. In one embodiment, the locking mechanism 122 may be in the form of a fastener such as, but not limited to, a magnet, a screw, a bolt, an adhesive, a hook and loop fastener, a tongue and groove fastener, etc. In another embodiment, the locking mechanism 122 may be in the form of a lock such as, but not limited to, a padlock, a deadbolt lock, a cam lock, a rim/mortise lock, a euro profile cylinder lock, an interchangeable core cylinder lock, a furniture latch lock, a rim latch lock, a biometric fingerprint scanning lock, an RFID keyfob lock, a Bluetooth lock that unlocks via a smart device mobile application, a mechanical dial lock, a numerical combination lock, a pedestal lock, a draw lock, a fixed core lock, etc. In one embodiment, the front surface 120 or other portions of the device, may comprise an ornamental design, indicia or logo.

The back surface 130 of the device 100 attaches to the gutter 10 via at least one fastener 132. The fastener 132 allows the device 100 to be securely fastened to the gutter 10 without the risk of becoming lose and falling from the gutter 10. There is a plurality of fastening means that may be used such as, but not limited to, hook and loop, snap, screw, bolt, tongue and grove, male/female joints, magnet, adhesive, or combinations therein. In the preferred embodiment, the fastener 132 is a universal fastener to allows the device 100 to be attached to a plurality of differing gutters 10.

The device 100 is also comprised of a top surface 140 comprised of at least one power source 144. In the preferred embodiment, the power source 144 receives power via at least one solar panel 142 positioned on the top surface 140. The power source 144 may be any power source such as a battery. In differing embodiments of the device 100, the solar panel 142 may be comprised of, but not limited to: monocrystalline silicon, polycrystalline silicon, or a photovoltaic cell film. The solar panel 142 allows the power source 144 to continually recharge so the user does not have to replace the power source 144. In one embodiment, the power source 144 may be charged via a 110v/240v power cord.

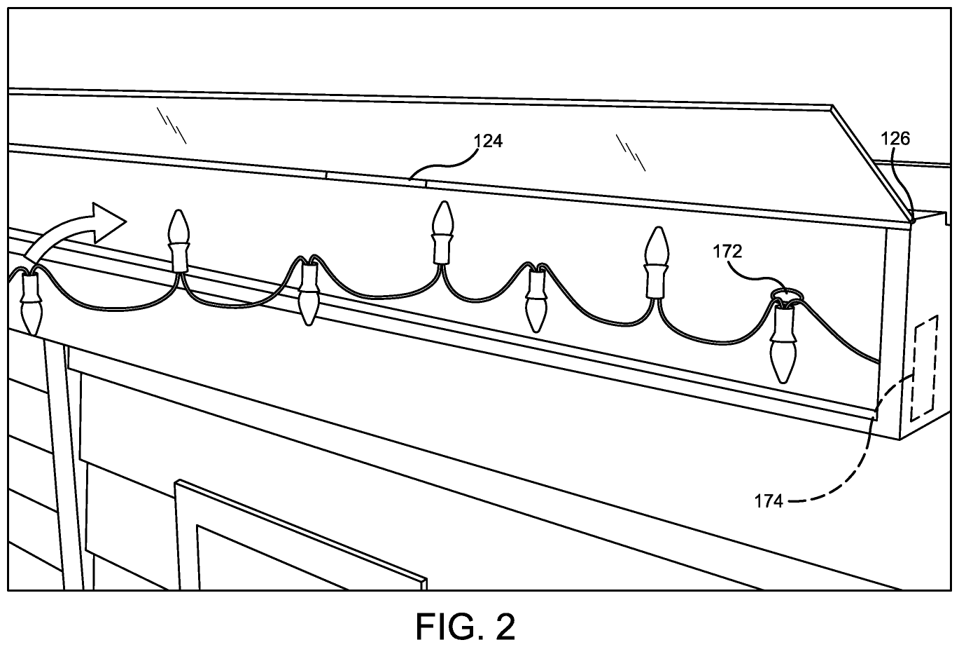

FIG. 2 illustrates an enhanced perspective view of one potential embodiment of a gutter-mounted light storage device 100 in an open position of the present invention in accordance with the disclosed architecture. The device 100 is comprised of an interior space 170 where the lights 12 are placed in order to be enclosed in the device 100.

In the preferred embodiment, there is a plurality of fasteners 172 positioned within the interior space 170 that allow the lights 12 to be securely attached to the device 100. This prevents the lights 12 from falling out of the interior space 170 when the front surface 120 is in the open position.

The device 100 is also comprised of at least one receiver 174 positioned within the interior space 170. The receiver 174 may be any receiver known in the art. The receiver 174 is in wireless electrical communication with a mobile application 200 on the user's smart device. This allows for the mobile application 200 to wirelessly communicate with the receiver 174, which then communicates with the lights 12. The lights 12 then execute the appropriate function that was selected on the mobile application 200. In different embodiments, the electronical communication capabilities of the device 100 may be, but are not limited to, GPS, WIFI, Bluetooth, RFID, NFC, cellular, etc.

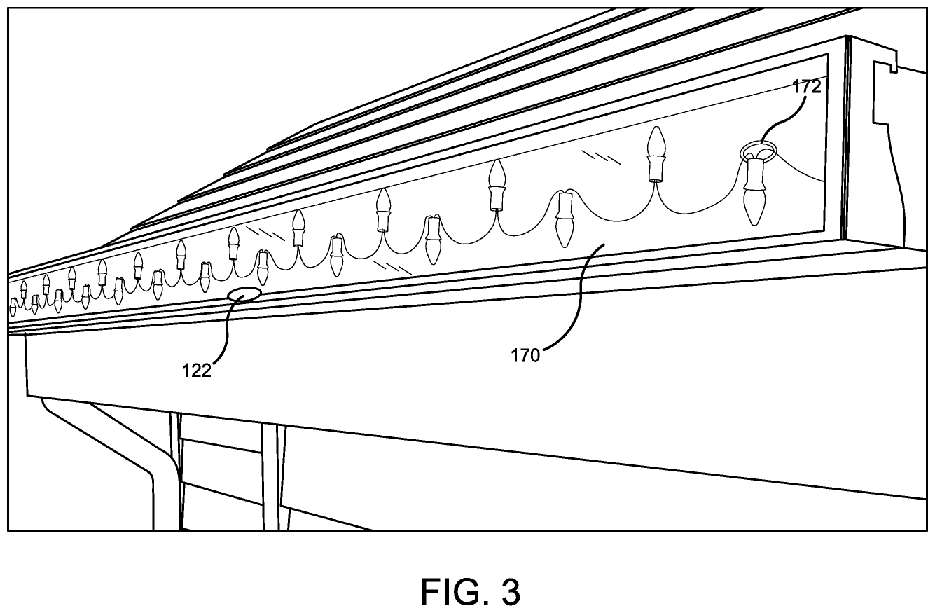

FIG. 3 illustrates an enhanced perspective view of one potential embodiment of a gutter-mounted light storage device 100 in a closed position of the present invention in accordance with the disclosed architecture. The device 100 in the closed position, allows the lights 12 to be concealed and safely secured in the interior space. Further, the locking mechanism 122 prevents the front surface 120 from opening when in the closed position.

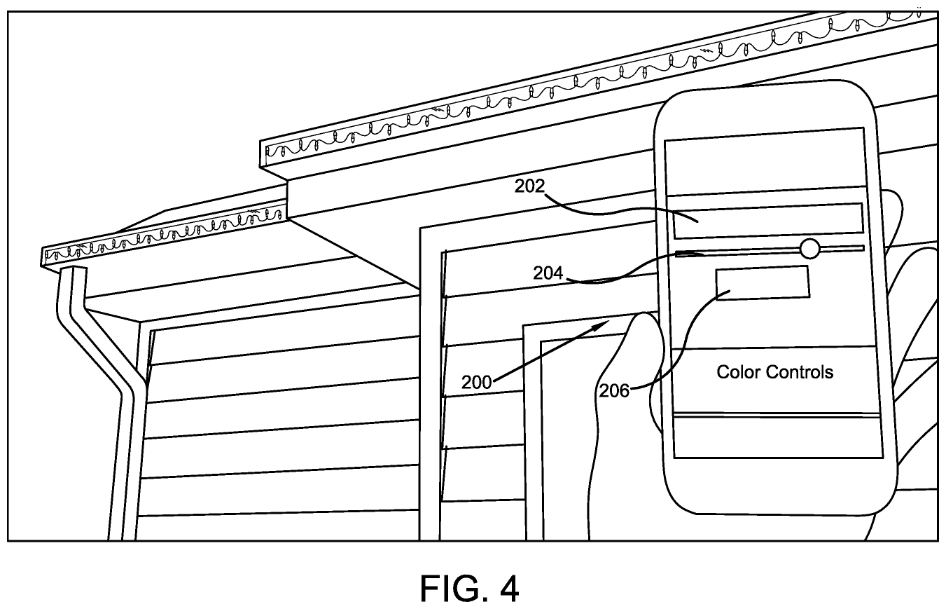

FIG. 4 illustrates a graphical view of one potential embodiment of a mobile application 200 of one potential embodiment of a gutter-mounted light storage device 100 of the present invention in accordance with the disclosed architecture. The mobile application 200 preferably may be comprised of color controls 202 that allow the user to select what color the lights 12 emit. The mobile application 200 may also be comprised of brightness controls 204 that allow the user to change the brightness of the lights 12. The mobile application 200 also may be comprised of functionality controls 206 that allow the user to select the functions of the lights 12, such as the speed in which the lights 12 flicker. In one embodiment, these controls are in the form of a plurality of buttons, in another embodiment, the mobile application 200 is comprised of sliders that allow the user to customize the lights 12. The mobile application 200 is further in wireless electronic communication with the receiver 174 positioned in the interior space 170.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “gutter-mounted light storage device” and “device” are interchangeable and refer to the gutter-mounted light storage device 100 of the present invention.

Notwithstanding the foregoing, the gutter-mounted light storage device 100 of the present invention and its various components can be of any suitable size and configuration as is known in the art without affecting the overall concept of the invention, provided that they accomplish the above-stated objectives. One of ordinary skill in the art will appreciate that the size, configuration and material of the gutter-mounted light storage device 100 as shown in the FIGS. are for illustrative purposes only, and that many other sizes and shapes of the gutter-mounted light storage device 100 are well within the scope of the present disclosure. Although the dimensions of the gutter-mounted light storage device 100 are important design parameters for user convenience, the gutter-mounted light storage device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A gutter-mounted light storage device comprising:
a top surface;
a front surface;
a hinge;
a bottom surface;
a back surface;
an interior space; and
a fastener.

2. The gutter-mounted light storage device of claim 1 further comprising a locking mechanism positioned on the front surface.

3. The gutter-mounted light storage device of claim 2, wherein the locking mechanism is comprised of a padlock, a deadbolt lock, a cam lock, a rim/mortise lock, a euro profile cylinder lock, an interchangeable core cylinder lock, a furniture latch lock, a rim latch lock, a biometric fingerprint scanning lock, an RFID keyfob lock, a Bluetooth lock that unlocks via a smart device mobile application, a mechanical dial lock, a numerical combination lock, a pedestal lock, a draw lock, or a fixed core lock.

4. The gutter-mounted light storage device of claim 1 further comprising a hinge lock positioned on the front surface.

5. The gutter-mounted light storage device of claim 4, wherein the hinge lock is comprised of a magnet, a screw, a nut, a bolt, a carriage bolt, a nail, an anchor bolt, an acorn nut, a threaded rod, a retaining ring, a rivet, a set screw, a toggle bolt, an anchor, a self-tapping screw, an adhesive, a u-bolt, a lock nut, or a castle nut.

6. The gutter-mounted light storage device of claim 1 further comprising a power source positioned on the top surface.

7. The gutter-mounted light storage device of claim 1 further comprising a back surface fastener positioned on the back surface.

8. The gutter-mounted light storage device of claim 7, wherein the back surface fastener is comprised of a hook and loop fastener, a snap fastener, a screw, a bolt, an adhesive, a tongue and grove fastener, a male/female joints, a magnet, or combinations therein.

9. The gutter-mounted light storage device of claim 1, wherein the hinge is comprised of an offset blind hinge, a knuckle hinge, a butt hinge, a rising butt hinge, a gravity pivot hinge, a ball bearing hinge, a barrel hinge, a concealed hinge, a knife hinge, a piano hinge, a strap hinge, a pivot hinge, a gas-piston hinge, an injection molded hinge, or a locking hinge.

10. A gutter-mounted light storage device comprising:
a top surface;
a power source;
a front surface;
a hinge, a locking mechanism, and a hinge lock, each of which are positioned on the front surface;
a bottom surface;
a back surface;
a first fastener positioned on the back surface;
an interior space; and
a second fastener positioned in the interior space.

11. The gutter-mounted light storage device of claim 10 further comprising a receiver positioned in the interior space.

12. The gutter-mounted light storage device of claim 10 further comprising a solar panel positioned on the top surface.

13. The gutter-mounted light storage device of claim 12, wherein the solar panel is comprised of a monocrystalline silicon, a polycrystalline silicon, or a photovoltaic cell film.

14. A gutter-mounted light storage device comprising:
a top surface;
a power source;
a solar panel;
a front surface;
a hinge;
a locking mechanism;
a hinge lock;
a bottom surface;
a back surface;
a first fastener;
an interior space;
a second fastener; and
a mobile application.

15. The gutter-mounted light storage device of claim 14, wherein the mobile application is comprised of a color control.

16. The gutter-mounted light storage device of claim 14, wherein the mobile application is comprised of a brightness control.

17. The gutter-mounted light storage device of claim 14, wherein the mobile application is comprised of a functionality control.

18. The gutter-mounted light storage device of claim 14, wherein the mobile application is comprised of a slider to operate a control.

19. The gutter-mounted light storage device of claim 14, wherein the mobile application is in wireless electrical communication with a receiver positioned in the interior space.

20. The gutter-mounted light storage device of claim 19, wherein the electrical communication is comprised of a GPS, a WIFI, a Bluetooth, a RFID, a NFC or a cellular communication.
